(19) United States
(12) Patent Application Publication
(10) Pub. No.: US 2009/0080524 A1
(43) Pub. Date: Mar. 26, 2009

(54) VIDEO DECODING APPARATUS AND VIDEO DECODING METHOD

(75) Inventors: Tatsuro Fujisawa, Akishima-shi (JP); Yoshihiro Kikuchi, Hamura-shi (JP); Hiroshi Yonekubo, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/212,547

(22) Filed: Sep. 17, 2008

(30) Foreign Application Priority Data
Sep. 25, 2007 (JP) 2007-248027

(51) Int. Cl. H04N 7/26

(52) U.S. Cl. 375/240.15; 375/E07.126

(57) ABSTRACT

According to one embodiment, a video decoding apparatus which decodes a compression-coded video stream, includes an error detection module configured to detect an error in a syntax values decoded by a decoding module, and an error concealment processing module configured to execute, in the case where the picture to be decoded whose error has been detected by the error detection module is an inter-frame prediction picture for which motion compensation prediction processing is performed, error concealment processing of rewriting the syntax values of the macroblock in which an error has been detected and its subsequent macroblocks so as to estimate, from information of the inter-frame prediction picture or data of macroblocks that have been decoded, data of the macroblock in which an error has been detected and its subsequent macroblocks.

### CROSS-REFERENCE TO RELATED APPLICATIONS

This application is based upon and claims the benefit of priority from Japanese Patent Application No. 2007-248027, filed Sep. 25, 2007, the entire contents of which are incorporated herein by reference.

### BACKGROUND

1. Field

One embodiment of the invention relates to a video decoding apparatus and a video decoding method which perform error concealment.

2. Description of the Related Art

At the present day, a portable multimedia player or a mobile phone having a tuner is getting more and more common. Such equipment can receive a One-Segment partial reception service (hereinafter, referred to as “One-Segment broadcasting”) for mobile phone/mobile terminal.

Viewers often enjoy One-Segment broadcasting while on the move. However, radio wave conditions change every moment as viewers move around. In particular, in a weak electrical field region, an error may occur in data that has been received and decoded in some cases. In the case where an error has occurred in the data, error concealment processing is performed at the time of video decoding.

Jpn. Pat. Appln. Publication No. 2007-67664 discloses a technique in which error concealment processing suitable for a generated image is performed so as to reduce degradation of image quality which is caused by the occurrence of an error.

One-Segment broadcasting is often received by mobile apparatuses. Such apparatuses are required to perform processing concerning video decoding with a load as low as possible in order to extend battery life. Accordingly, the error concealment processing is required to be performed with a load as low as possible.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exterior view of a video decoding apparatus according to an embodiment of the present invention;

FIG. 2 is a block diagram showing a system configuration of the video decoding apparatus shown in FIG. 1;

FIG. 3 is a block diagram showing a functional configuration of a video decoding module of a One-Segment broadcasting reproduction application used in the video decoding apparatus shown in FIG. 1;

FIG. 4 is a flowchart showing a procedure of error detection processing performed by an error detection module shown in FIG. 3;

FIG. 5 is a block diagram showing a configuration of an error concealment processing module shown in FIG. 3;

FIG. 6 is a flowchart showing a detailed procedure of the error detection processing performed by the error detection module shown in FIG. 3;

FIG. 7 is a flowchart showing a detailed procedure of the error detection processing performed by the error detection module shown in FIG. 3; and

FIG. 8 is a flowchart showing a procedure of error concealment processing performed by the error concealment processing module shown in FIG. 3;

FIG. 9 is a flowchart showing another procedure of the error concealment processing performed by the error concealment processing module shown in FIG. 3; and

FIG. 10 is a flowchart showing another procedure of the error concealment processing performed by the error concealment processing module shown in FIG. 3.

### DETAILED DESCRIPTION

Various embodiments according to the invention will be described hereinafter with reference to the accompanying drawings. In general, according to one embodiment of the invention, a video decoding apparatus which decodes a compression-coded video stream, comprises a decoding module configured to decode syntax values of respective macroblocks included in a picture to be decoded in the video stream, an error detection module configured to detect an error in the syntax values decoded by the decoding module, an error concealment processing module configured to execute, in the case where the picture to be decoded whose error has been detected by the error detection module is an inter frame prediction picture for which motion compensation prediction processing is performed, error concealment processing of rewriting the syntax values of the macroblock in which an error has been detected and its subsequent macroblocks so as to estimate, from information of the inter frame prediction picture or data of macroblocks that have been decoded, data of the macroblock in which an error has been detected and its subsequent macroblocks, a compensation prediction module configured to execute motion compensation prediction processing of generating, from one or more reference pictures, an inter frame prediction signal corresponding to the picture to be decoded in accordance with the syntax values decoded by the decoding module or syntax values rewritten by the error concealment processing module, an intra frame prediction processing module configured to execute intra frame prediction processing of generating an intra frame prediction signal from the picture to be decoded in accordance with the syntax values decoded by the decoding module or syntax values rewritten by the error concealment processing module, and a signal adding module configured to add one of the inter frame prediction signal and intra frame prediction signal to a prediction error signal corresponding to the picture to be decoded so as to decode the picture to be decoded.

First, with reference to FIG. 1, a configuration of a video decoding apparatus according to an embodiment of the present invention will be described.

A video decoding apparatus of FIG. 1 is a mobile apparatus such as a personal computer, a PDA, or an AV (audio/video) player, and can be driven by an internal battery. Hereinafter, it is assumed that the video decoding apparatus is embodied as a multimedia player 11 for reproducing audio or video data.

An LCD 12 serving as a display device and various operation buttons (back button 13, start button 14, OK button 15, up/down/left/right button 16, One-Segment button 17 are provided on the front surface of the main body of the multimedia player 11.

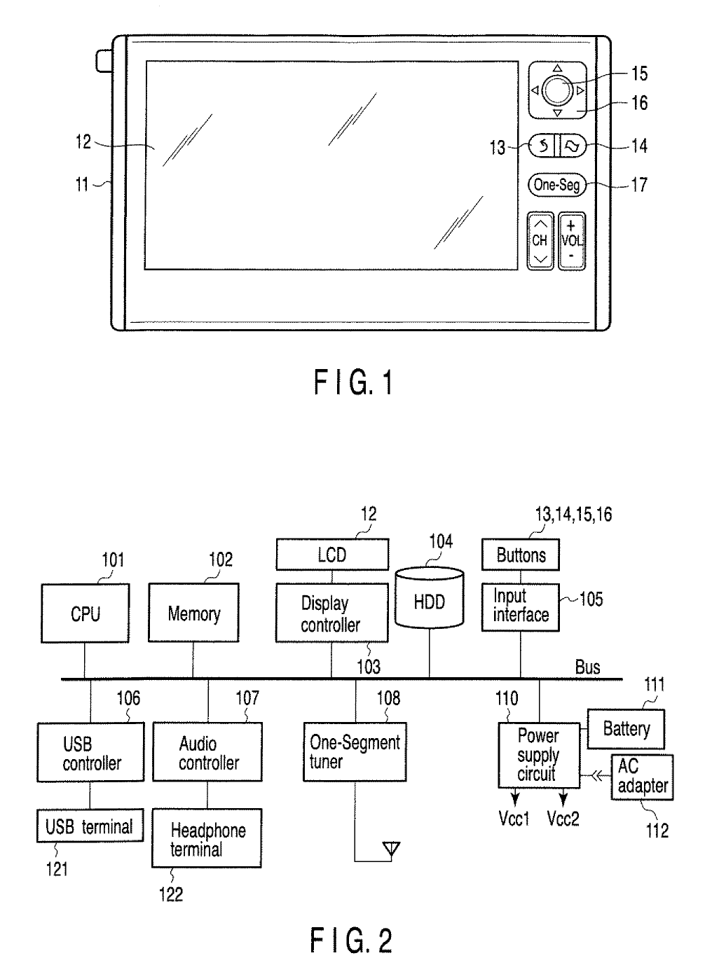

With reference to FIG. 2, a system configuration of the multimedia player 11 will be described.

As shown in FIG. 2, the multimedia player 11 includes a CPU 101, a memory 102, a display controller 103, a hard disk drive (HOD) 104, an input interface module 105, a USB controller 106, an audio controller 107, a One-Seg tuner 108, a wireless LAN module 109, a power supply circuit 110, and a battery 111.

The CPU 101 is a processor for controlling operation of the multimedia player 11 and executes various programs (operating system, application program, and the like) loaded into the memory 102. The application program is a program for executing reproduction of audio and video data and reproduction of One-Segment broadcasting.

The display controller 103 controls the LCD 12 so as to display various operation menus and images corresponding to video data reproduced by the application program on the display screen of the LCD 12. The HDD 104 functions as a storage device for storing various data such as audio and video data. The USB controller 106 is connected to a USB terminal 121 provided in the main body of the multimedia player 11 and executes communication with various external devices connected to the USB terminal 121. The audio controller 107 is an audio source device, which generates a sound signal corresponding to audio data reproduced by the application program and outputs the sound signal to a headphone terminal 122.

The One-Seg tuner 108 is provided for receiving One-Segment broadcasting for mobile terminals. The One-Seg tuner 108 includes a tuner circuit, OFDM demodulators, and an error correction module. The tuner circuit extracts a signal component of a frequency corresponding to a desired reception channel from a digital broadcasting signal (high frequency signal) input thereto from an antenna and transforms, using a mixer, the extracted signal component into an intermediate frequency signal, as well as amplifies, using an amplifier, the obtained intermediate frequency signal to a predetermined power level suitable for input to the respective OFDM demodulators.

The OFDM demodulators each A/D transform the intermediate frequency signal input thereto from the tuner circuit to obtain a digital signal, demodulate the obtained digital signal into a complex digital signal by orthogonal demodulation, perform FFT (fast Fourier transformation) to separate the complex digital signal into a sub-carrier signal on the frequency axis and, finally, output a demodulated signal for reproduction of One-Segment broadcasting.

In the One-Segment broadcasting, coding for error correction is performed by Reed-Solomon coding and convolution coding.

The transport stream is a data stream in which compression-coded broadcasting program data are multiplexed. In digital terrestrial TV broadcasting, a transport stream (TS) corresponding to broadcasting program data of each channel includes compression-coded video data, compression-coded audio data, and graphics data. The graphics data has also been compression coded.

A One-Segment broadcasting reproduction application executed in the CPU 101 separates the demodulated transport stream (TS) into video data and audio data. A software/video decoding module of the One-Segment broadcasting reproduction application decodes a video stream encoded in H.264/AVC format and sends the decoded video stream to the display controller 103. The display controller 103 generates a video signal corresponding to the decoded data. When the video signal is input to the LCD 12, the LCD 12 displays video images corresponding to the One-Segment broadcast.

Further, the One-Segment broadcasting reproduction application sends audio data encoded in AAC format to the audio controller 107. The audio controller 107 decodes audio data to generate an audio signal. The generated audio signal is input to a headphone through the headphone terminal 122 and, then, audio of the One-Segment broadcast is output from the headphone.

The power supply circuit 110 uses power from the battery 111 provided in the main body of the multimedia player 11 or power from an external AC adapter 112 to supply operating power to respective components.

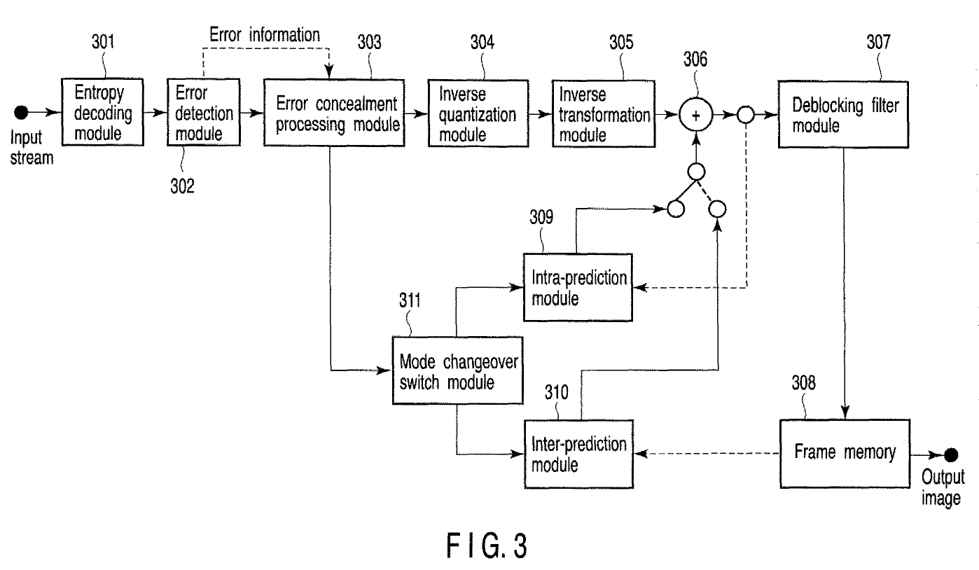

With reference to FIG. 3, a functional configuration of a video decoding module embodied by the One-Segment broadcast reproduction application will be described.

The video decode module of the One-Segment broadcast reproduction application complies with the H.264/AVC standard and includes, as shown in FIG. 3, an entropy decoding module 301, an error detection module 302, an error concealment processing module 303, an inverse quantization module 304, an inverse transformation module 305 such as of inverse DCT, an adding module 30C, a deblocking filter module 307, a frame memory 308, an intra-prediction module 309, an inter-prediction module 310, and a mode changeover switch module 311. Although the orthogonal transformation of H.264 performed by the inverse transformation module 305 is carried out at the accuracy of integer level and is different from conventional DCT in this point, the term DCT is used hereinafter for the shake of convenience.

Coding of each picture is executed in units of macroblocks of, e.g., 16×16 pixels. Any one of an intra-frame coding mode (intra-coding mode) and inter-frame prediction coding mode (inter-coding mode) is selected for each macroblock.

In the inter-frame prediction coding mode, a motion compensation inter-frame prediction signal corresponding to a picture to be coded is generated in fixed units of form (for example blocks) by predicting a motion of the picture to be coded from the coded picture. A prediction error signal generated by subtracting the motion compensation inter-frame prediction signal from the picture to be coded is coded by orthogonal transformation (DCT), quantization and entropy coding. In the intra-coding mode, a prediction signal of a picture to be coded is generated from the picture to be coded and then it is coded by orthogonal transformation (DCT), quantization and entropy coding.

In MPEG-2 or MPEG-4, the coding mode is determined in units of pictures. However, in the case of the H.264/AVC standard, the coding mode is determined in units of slices constituting one picture, and a plurality of coding modes can be used in a mixed manner in one picture.

Some NAL units are grouped in one segment called “access unit” for access in units of pictures. The access unit includes SPS (Sequence Parameter Set), PPS (Picture Parameter Set), and main picture information.

The SPS is a header that includes information, such as profile or level of an image, concerning coding of the entire sequence. The PPS is a header that indicates the coding mode of the entire picture. The main picture information is a data set of a plurality of macroblock data included in the picture.

There may be a case where there exists no PPS corresponding to the header of the entire picture, so that the starting position of the picture cannot be found by the PPS. The segment of the picture is detected by referring to a frame number included in the header of each slice to determine whether some information, such as the frame number, differs from those of an immediately preceding NAL unit.

The data of each macroblock has information for use in decoding. The information for use in decoding includes prediction mode information, prediction block size, prediction direction information, reference picture index, motion vector information, and DCT coefficient.

Hereinafter, operation of a video decoding module (software decoder) of FIG. 3 will be described.

A video stream that has been compression-coded in H.264/AVC format is first input to the entropy decoding module 301. The compression-coded video stream includes, in addition to coded image information corresponding to one picture, prediction block size information, reference picture index, and motion vector information used in the inter-frame prediction coding (inter-prediction coding), intra-frame prediction information used in the intra-frame prediction coding (intra-prediction coding), and mode information indicating a prediction mode (inter-prediction coding/intra-prediction coding).

The decoding processing is executed in units of macroblocks of, e.g., 16×16 pixels. The entropy decoding module 301 performs entropy decoding processing, which is similar to variable-length decoding, on the video stream, and separates from the video stream syntax values, such as a DCT coefficientr prediction block size, motion vector information (motion vector differential information), intra-frame prediction information, reference picture index, and prediction mode information. In this case, for example, each of the macroblocks in the picture to be decoded is subjected to the entropy decoding processing in units of blocks of 4×4 pixels (or 8×8 pixels), and is transformed into a 4×4 (or 8×8) quantization DCT coefficient. It is assumed, in the following explanation, that each block consists of 4×4 pixels.

The motion vector information is sent to the inter-prediction module 310 through the mode changeover switch module 311. The intra-frame prediction information is sent to the intra-prediction module 309 though the mode changeover switch module 311. The mode information is sent to the mode changeover switch module 311.

The 4×4 quantization DCT coefficient of each of blocks to be decoded is transformed into a 4×4 DCT coefficient (orthogonal transformation coefficient) by inverse quantization processing of the inverse quantization module 304. The 4×4 DCT coefficient is transformed into a 4×4 pixel value by inverse integer DCT (inverse orthogonal transformation) processing of the inverse transformation module 305 on the basis of frequency information. The 4×4 pixel value is a prediction error signal corresponding to a block to be decoded. The prediction error signal is sent to the adding module 306, and a prediction signal (motion compensation inter-frame prediction signal or intra-frame prediction signal) corresponding to the block to be decoded is added to the above prediction error signal in the adding module 306, whereby decoding of the 4×4 pixel value corresponding to the block to be decoded is completed.

In the intra-prediction mode, the intra-prediction module 309 is selected by the mode changeover switch module 311, as a result of which the intra-frame prediction signal obtained by the intra-prediction module 309 is added to the prediction error signal. In the inter-prediction mode, the inter-prediction module 310 is selected by the mode changeover switch module 311, as a result of which the motion compensation inter-frame prediction signal is added to the prediction error signal.

In such a manner, the prediction signal (motion compensation inter-frame prediction signal or intra-frame prediction signal) is added to the prediction error signal corresponding to the block to be decoded, and processing for decoding the picture to be decoded is carried out in units of predetermined blocks.

Each of the decoded pictures is stored in the frame memory 308, after being subjected to the deblocking filter processing of the deblocking filter module 307. To be more specific, the deblocking filter module 307 performs deblocking filter processing for reducing block noise on each decoded picture in units of blocks consisting of, e.g., 4×4 pixels. The deblocking filter processing prevents block distortion from being included in the reference picture and thereby being propagated also to another decoded picture. The deblocking filter processing is appropriately carried out such that strong filtering is performed on part of a decoded picture in which block distortion easily occurs, and weak filtering is performed on part of the decoded picture in which block distortion does not easily occur. The deblocking filter processing is carried out by loop filter processing.

Then, each picture subjected to the deblocking filter processing is read out from the frame memory 308 as an output picture frame (or output picture field). Furthermore, each of the pictures to be used as reference pictures for the motion compensation inter-frame prediction is held in the frame memory 308 for a given time period. In motion compensation inter-frame prediction encoding complying with the H.264/AVC standard, a number of pictures can be used as reference pictures. Thus, the frame memory 308 includes a plurality of frame memory modules for storing picture data corresponding to a plurality of pictures.

The inter-prediction module 310 performs inter-frame prediction processing for generating a motion compensation inter-frame prediction signal from the picture to be decoded. The inter-prediction module 310 performs motion compensation prediction processing for an inter-frame prediction signal corresponding to the picture to be decoded from one reference picture that has been subjected to the deblocking filter processing based on motion vector information corresponding to the picture to be decoded. The motion compensation prediction processing includes processing of applying pixel interpolation processing to the reference pictures to be referred to according to the reference picture index and processing of generating, from the reference pictures that have been subjected to the pixel interpolation processing, an inter-frame prediction signal corresponding to the picture to be decoded based on the vector information included in the video stream. That is, the inter-prediction module 310 applies pixel interpolation processing to the decoded picture (reference picture) to generate a prediction interpolation signal including a pixel group of decimal accuracy. The inter-prediction module 310 then performs motion compensation prediction based on the motion vector information to generate an inter-frame prediction signal corresponding to the picture to be decided from the prediction interpolation signal obtained by the pixel interpolation processing.

The intra-prediction module 309 performs intra-frame prediction processing of producing, from the picture to be decoded, an intra-frame prediction signal for a block to be decoded in the picture. The intra-prediction module 309 performs intra-frame prediction processing (also referred to as “intra-prediction processing”) based on the intra-frame prediction information to produce an intra-frame prediction signal from a pixel value regarding another block which is already decoded and located close to the block to be decoded in the above picture. As the size of the block to be decoded, there exists two prediction block size of 4×4 and 16×16. With respect to the 4×4 prediction block size, one of nine prediction modes: vertical prediction (prediction mode 0), horizontal prediction (prediction mode 1), DC prediction (prediction mode 2) diagonal-down-left prediction (prediction mode 3), diagonal-down-right prediction (prediction mode 4), vertical right prediction (prediction mode 5), horizontal down prediction (prediction mode 6), vertical left prediction (prediction mode 7), and horizontal up prediction (prediction mode 8) is selected in units of prediction blocks in accordance with the prediction direction information. Further, with respect to the 16×16 prediction block size, one of four prediction modes: vertical prediction (prediction mode 0), horizontal prediction (prediction mode 1), DC prediction (prediction mode 2), and plane prediction (prediction mode 3) is selected in units of prediction blocks in accordance with prediction direction information.

There may be a case where an error is contained in video stream (input stream) data to be input to the entropy decoding module 301 in some reception environments. Therefore, an error concealment function of interpolating an image of the area corresponding to data that has been lost due to the error is important.

The error detection module 302 determines, for each macroblock, whether an error is contained in the input stream data. The error detection module 302 then outputs, to the error concealment processing module 303, error information including an error flag indicating the presence/absence of the error and number of the macroblock for which the determination has been made. In the case where the error flag is effective, the error information indicates that an error has occurred in the macroblock corresponding to the number included in the error information. In the case where the error flag is ineffective, the error information indicates that an error has not occurred in the macroblock corresponding to the number included in the error information.

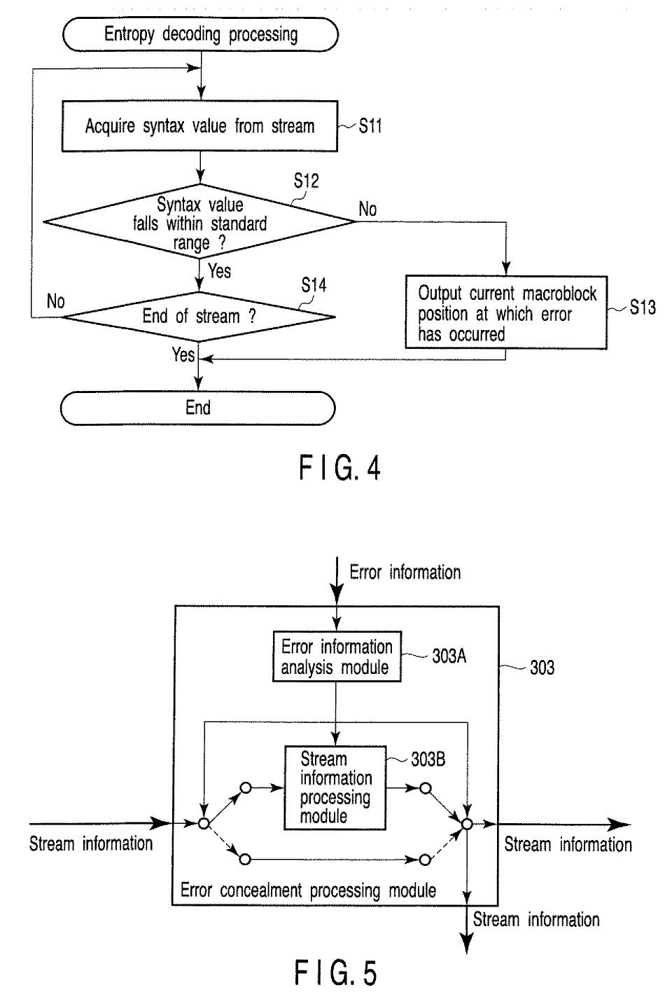

As shown in the flowchart of FIG. 4, the error detection module 302 acquires syntax values from the stream in order to detect an error (block S11) and determines that the each of the syntax values falls within a standard range (block S12). When each of the syntax values falls within a standard range, the error detection module 302 determines that an error is not contained in the stream. On the other hand, when the header value of the picture or each of the syntax values falls outside a standard range, the error detection module 302 determines that an error is contained in the stream and outputs the current macroblock position at which the error has occurred (block S13).

As shown in FIG. 5, the error concealment processing module 303 includes an error information analysis module 303A and a stream information processing module 303B. The error information analysis module 303A analyzes the error information output from the error detection module 302 to determine the presence/absence of an error. With respect to the macroblock in which no error has occurred, the error concealment processing module 303 outputs input stream information without applying any processing thereto. When detecting the presence of an error from the error information, the error information analysis module 303A notifies the stream information processing module 303B of the number of the macroblock in which the error has occurred. The stream information processing module 303B performs processing of rewriting the syntax values of the macroblock in which the error has occurred in order to estimate lost data following the error data from the header information of the picture, or information of the macroblocks that have normally been decoded.

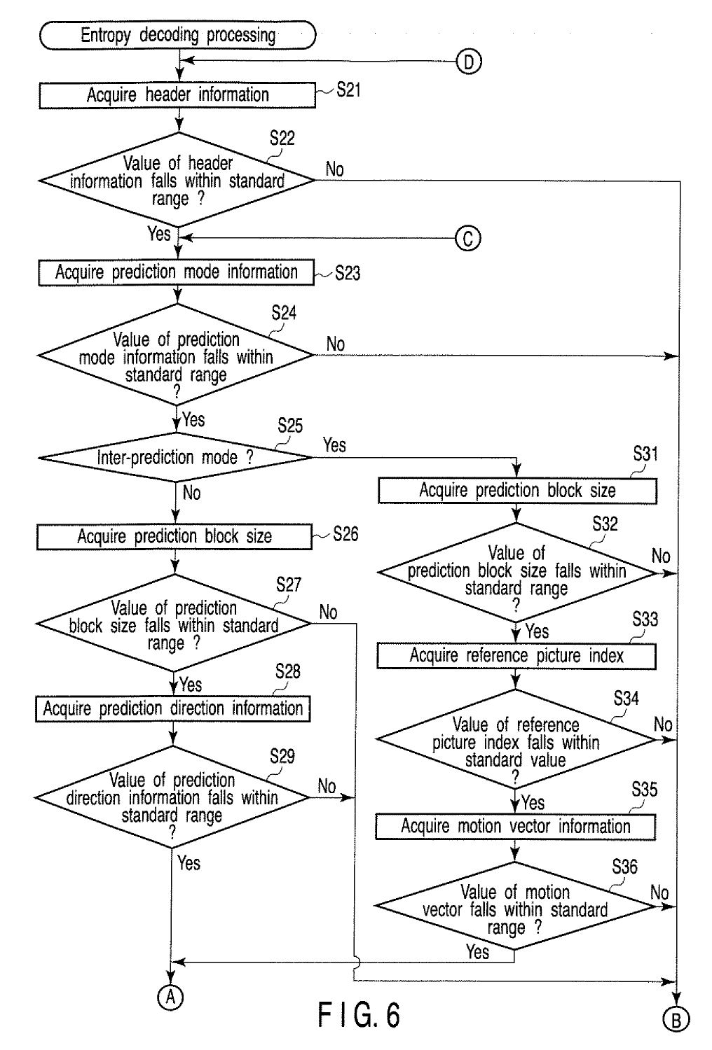

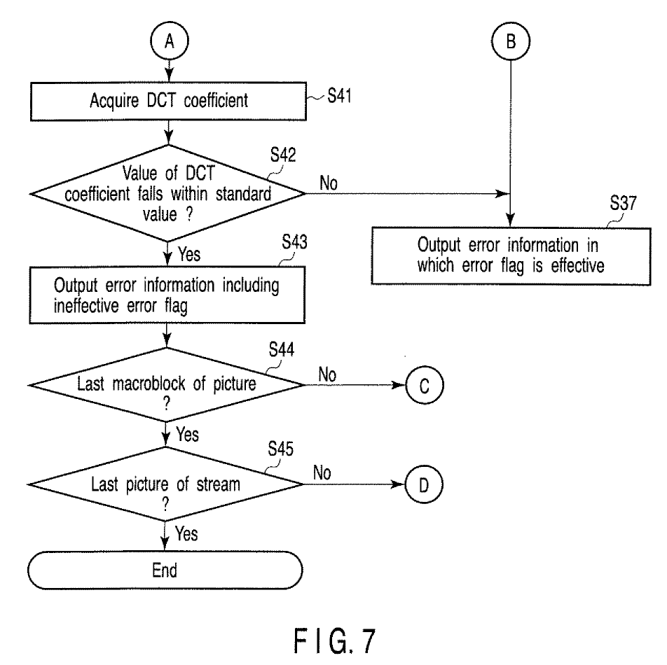

With reference to the flowcharts of FIGS. 6 and 7, a detailed procedure of the error detection performed by the error detection module 302 will be described.

The error detection module 302 acquires the header information of the picture (block S21) to determine whether the value of the header information falls within a standard range (block S22). When the value of the header information falls outside a standard range (No in block S22), the error detection module 302 determines that an error has occurred and outputs, to the error concealment processing module 303, error information including the number of the starting macroblock of the picture and error flag indicating the presence of the error in the macroblock (block S37).

An example of the header information of the picture acquired in block S21 includes information concerning the coding of the entire sequence, such as profile or level of the picture. This information corresponds to the SPS (Sequence parameter Set) in H.264/AVC standard. Another example of the header information of the picture includes information indicating the coding mode of the entire picture. This information corresponds to the PPS (Picture Parameter Set) in H.264/AVC standard.

When the value of the header information falls within a standard range (Yes in block S22), the error detection module 302 acquires prediction mode information indicating intra-prediction mode or inter-prediction mode (block S23) and determines whether the value of the prediction mode information falls within a standard range (block S24). The case where the value falls outside a standard range indicates that one of the intra-prediction mode and inter-prediction mode is not specified.

When the value of the prediction mode information falls outside a standard range (No in block S24), the error detection module 302 determines that an error has occurred and outputs, to the error concealment processing module 303, error information including the effective error flag and number of the current macroblock for which the error detection has been made (block S37).

When the value of the prediction mode information falls within a standard range (Yes in block S24), the error detection module 302 determines whether the macroblock for which the error detection has been made is the inter-prediction mode (block S25). When determining that the relevant macroblock is not the inter-prediction mode (No in block S25), i.e., when determining that the relevant macroblock is the intra-prediction mode, the error detection module 302 acquires the prediction block size (block S26).

In the case of the H.264/AVC standard, the prediction block size of the inter-prediction mode is one of 16×16, 16×8, 8×16, 8×8, 8×4, 4×8, and 4×4. Then, the error detection module 302 determines whether the value of the acquired prediction block size falls within a standard range (block S27). When the value of the acquired prediction block size falls outside a standard range (No in block S27), the error detection module 302 determines that an error has occurred and outputs, to the error concealment processing module 303, error information including the effective error flag and number of the current macroblock for which the error detection has been made (block S37).

When the value of the acquired prediction block size falls within a standard range (Yes in block S27), the error detection module 302 acquires the prediction direction information (block S28). In the case where the block size is 4×4 in the inter-prediction mode in the H.264/AVC standard, the prediction direction is one of the prediction modes 0 to 8. In the case where the block size is 16×16 in the inter-prediction mode in the H.264/AVC standard, the prediction direction is one of the prediction modes 0 to 3.

When the value of the acquired prediction direction information falls outside a standard range (No in block S29), the error detection module 302 determines that an error has occurred and outputs, to the error concealment processing module 303, error information including the effective error flag and number of the current macroblock for which the error detection has been made (block S37).

When determining that the macroblock for which the error detection has been made is the inter-prediction mode (Yes in block S23), the error detection module 302 acquires the prediction block size (block S31) and then determines whether the value of the acquired prediction block size falls within a standard range. In the case of the H.264/AVC standard, the prediction block size of the inter-prediction mode is one of 16×16, 16×8, 8×16, 8×8, 8×4, 4×8, and 4×4. When the value of the acquired prediction block size falls outside a standard range (No in block S32), the error detection module 302 determines that an error has occurred and outputs, to the error concealment processing module 303, error information including the effective error flag and number of the current macroblock for which the error detection has been made (block 837).

When the value of the acquired prediction direction information falls within a standard range (Yes in block S32), the error detection module 302 acquires the reference picture index (block S33) and determines whether the value of the reference picture index falls within a standard range (block S34). If, e.g., a future picture is referred to, the value of the reference picture index falls outside a standard range.

When the value of the reference picture index trails outside a standard range (No in block S34), the error detection module 302 determines that an error has occurred and outputs, to the error concealment processing module 303, error information including the effective error flag and number of the current macroblock for which the error detection has been made (block S37).

When the value of the reference picture index falls within a standard range (Yes in block S34), the error detection module 302 acquires the motion vector information (block S35) and determines whether the value of the motion vector information falls within a standard range (block S36). When the value of the motion vector information falls outside a standard range (No in block S36), the error detection module 302 determines that an error has occurred and outputs, to the error concealment processing module 303, error information including the effective error flag and number of the current macroblock for which the error detection has been made (block S37).

When the value of the prediction direction information falls within a standard value (Yes in block S29) or when the value of the motion vector information falls within a predetermined value (Yes in block S36), the error detection module 32 acquires the DCT coefficient (block S41) and determines whether the value of the DCT coefficient falls within a standard range (block S42). When the value of the DCT falls outside a standard value (No in block S42), the error detection module 302 determines that an error has occurred and outputs, to the error concealment processing module 303, error information including the effective error flag and number of the current macroblock in which an error has occurred (block S37).

When the value of the DCT falls within a standard value (Yes in block S42), the error detection module 302 outputs, to the error concealment processing module 303, error information including the ineffective error flag and number of the current macroblock in which an error has occurred (block S43).

Then, the error detection module 302 determines whether the current macroblock is the last macroblock of the picture (block S44). When the current macroblock is not the last macroblock of the picture (No in block 344), the flow returns to block 323, where the error detection module 302 acquires the prediction mode information of the subsequent macroblock and executes processing of block S24 and subsequent blocks again.

When the current macroblock is the last macroblock of the picture (Yes in block 344), the error detection module 302 then determines whether the current picture is the last picture of the stream (block S45). When the current picture is not the last picture of the stream (No in block S45), the flow returns to block S21, where the error detection module 302 acquires the header information of the subsequent picture and executes processing of block S22 and subsequent blocks again. When the current picture is the last picture of the stream (Yes in block S45), the error detection module 302 ends this flow.

With the above processing, the error detection module 302 detects whether an error has occurred in respective macroblocks and outputs the error information.

The error concealment processing performed by the error concealment processing module 303 will next be described in detail. The error concealment processing module 303 rewrites the syntax value depending on the content of the error information received from the error detection module to thereby achieve the error concealment processing. The rewrite processing for the syntax value differs depending on whether the picture containing an error is I-picture or P-picture.

That is, in the case where the picture containing an error is I-picture, the error concealment processing module 303 sets the prediction mode of the macroblock type of the macroblock in which an error has been detected and subsequent macroblocks to “intra 4×4 prediction mode”, sets the prediction direction thereof to DC (mean value) mode, and sets all the DCT coefficients thereof to 0 so that the prediction error signal becomes 0.

In the case where the picture containing an error is P-picture, the error concealment processing module 303 sets the prediction mode of the macroblock of the macroblock in which an error has been detected and subsequent macroblocks to “skipped macroblock”. In the skipped macroblock mode, information of macroblocks is not sent, but pixels of reference pictures located at spatially the same position are used directly as a coded image. However, in the case of the H.264/AVC standard, motion compensation prediction is carried out using the prediction motion vector. In this skipped macroblock mode, pixels of reference pictures located at spatially the same position that have been subjected to motion compensation prediction are used directly as a coded image, so that the prediction error signal becomes 0.

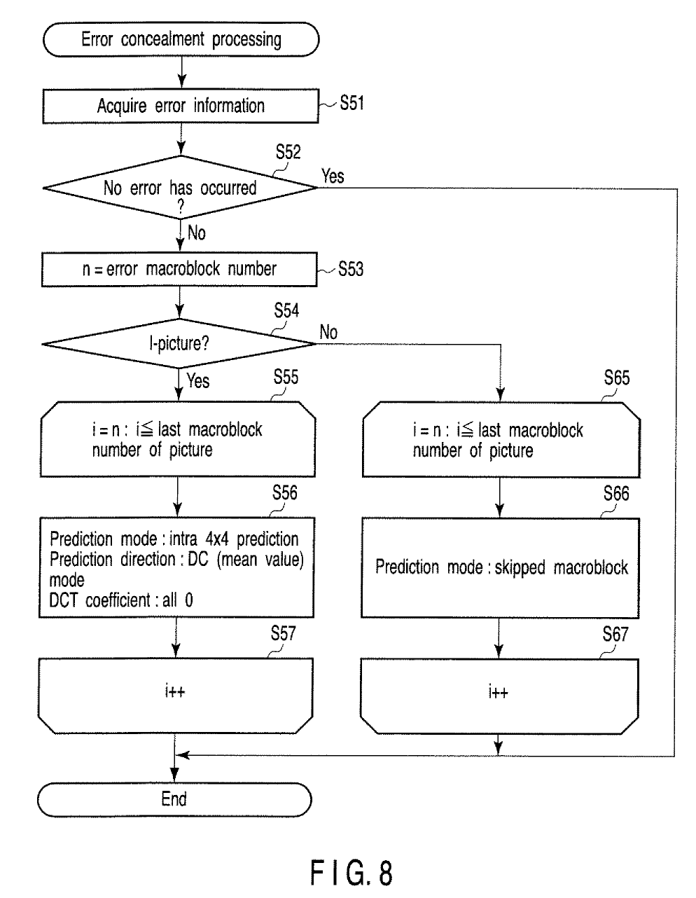

The concrete processing of the error concealment processing module 303 will be described with reference to the flowchart of FIG. 8.

The error information analysis module 303A acquires the error information sent from the error detection module 302 (block S51). The error information analysis module 303A then refers to the error flag in the error information to determine whether no error has occurred (block S52). When determining that an error has occurred (No in S52), the error information analysis module 303A acquires the macroblock number indicated by the error information and notifies the stream information processing module 303B of the acquired macroblock number (block S53). Then the stream information processing module 303B determines whether the picture being processed is I-picture (block S54). When determining that the picture being processed is I-picture (Yes in block S54), the stream information processing module 303B rewrites the syntax values of the macroblock in which an error has been detected and subsequent macroblocks up to the last macroblock (blocks S55 to S57).

In the rewrite processing of block S56, the stream information processing module 303B sets the prediction mode to “intra 4×4 prediction mode”, sets the prediction direction information to DC (mean value) mode, and sets all the DCT coefficients to 0.

When determining in block S54 that the picture being processed is not I-picture (No in block S54), i.e., when determining that the picture being processed is P-picture, the stream information processing module 303B rewrites the syntax values of the macroblock in which an error has been detected and subsequent macroblocks up to the last macroblock (blocks S65 to S67). In the rewrite processing of block S66, the stream information processing module 303B sets the prediction mode of the macroblock in which an error has been detected and subsequent macroblocks up to the last macroblock to “skipped macroblock”.

With the above processing, the error concealment processing can be achieved to cope with an error occurring in the macroblock. This processing only includes rewriting the syntax values into values according to specifications, so that the load applied on the CPU 101 is small.

The macroblocks whose syntax values have been rewritten by the stream information processing module 303B are subjected to the same processing as those for the macroblocks whose syntax value are not written by the inverse quantization module 304, inverse transformation module 305, adding module 30C, deblocking filter module 307, intra-prediction module 309, inter-prediction module 310, and mode changeover switch module 311. As a result, images of the macroblock in which an error has occurred and subsequent macroblocks are displayed from information of the macroblocks that have normally been decoded.

In the H.264/AVC standard, a P-picture can contain a P-slice and an I-slice in a mixed manner. Generally, a P-picture is composed of only a P-slice.

However, in the future, there is a possibility that a video stream containing a P-picture composed of a P-slice and an I-slice will be broadcasted.

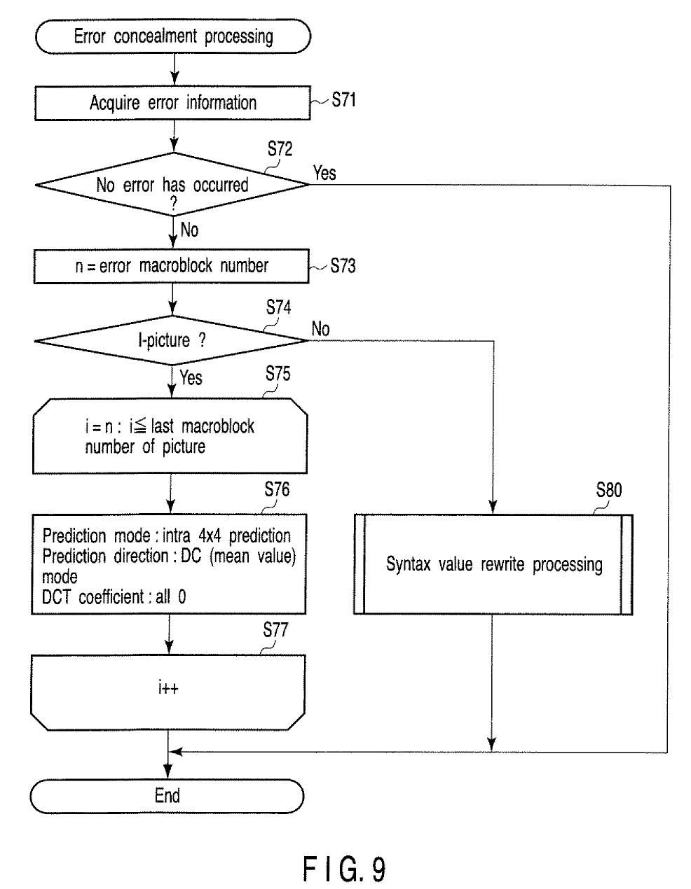

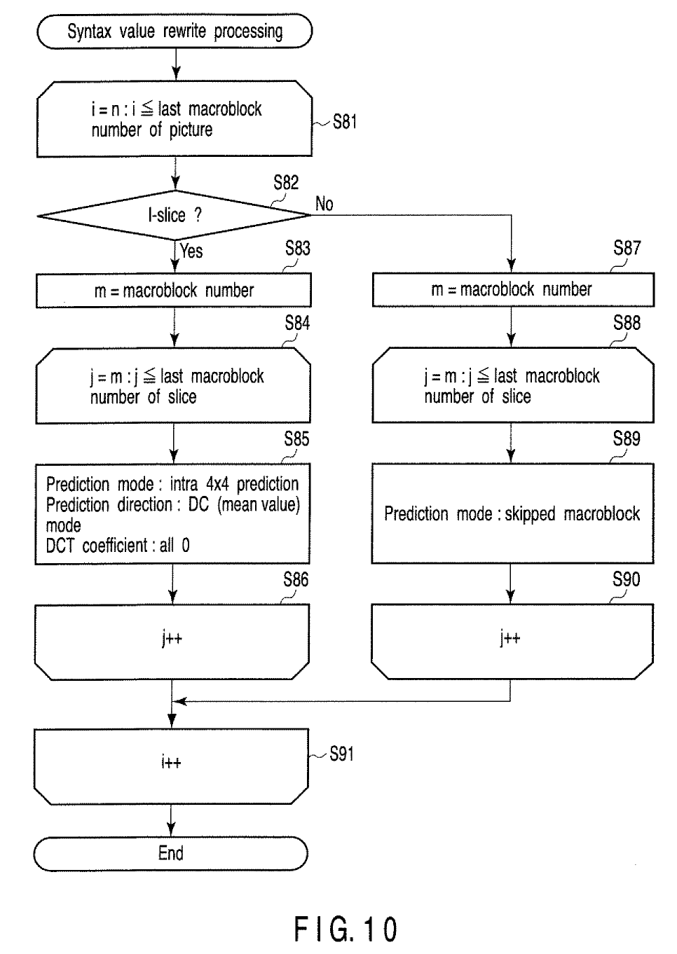

Processing for video stream broadcasting containing a P-picture composed of a P-slice and an I-slice will be described below with reference to FIGS. 9 and 10.

The error information analysis module 303A acquires the error information (block S71). The error information analysis module 303A refers to error information and then refers to the error flag in the error information to determine whether no error has occurred (block S72). When determining that an error has occurred, the error information analysis module 303A acquires the macroblock number indicated by the error information and notifies the stream information processing module 303B of the acquired macroblock number (block S73). Then the stream information processing module 303B determines whether the picture being processed is I-picture (block S74). When determining that the picture being processed is I-picture, the stream information processing module 303B rewrites the syntax values of the macroblock in which an error has been detected and its subsequent macroblocks up to the last macroblock (blocks S75 to S77). In the rewrite processing of block S76, the stream information processing module 303B sets the prediction mode to “intra 4×4 prediction mode”, sets the prediction direction to DC (mean value) mode, and sets all the DCT coefficients to 0.

When determining in block S74 that the picture being processed is not I-picture (No in block S74), i.e., when determining that the picture being processed is P-picture, the stream information processing module 303B performs different syntax value rewrite processing for the P-slice and I-slice.

The rewrite processing of block S80 will be described with reference to FIG. 10.

In this processing, the stream information processing module 3033 performs different rewrite processing for the syntax values of the macroblock in which an error has been detected and its subsequent macroblocks up to the last macroblock depending on whether the target macroblock belongs to the I-slice or P-slice (blocks S81 to S91). In the case of the P-slice, the stream information processing module 303B sets the prediction mode of the respective macroblocks to the skipped macroblock (block S89). In the case of the I-slicer the stream information processing module 303B sets the prediction mode of the respective macroblocks to “intra 4×4 prediction mode”, sets the prediction direction thereof to DC (mean value) mode, and sets all the DCT coefficients thereof to 0.

With the above processing, even when the P-slice and I-slice are contained in a P-picture in a mixed manner, adequate rewrite processing can be carried out depending on the slice type.

The entire decode control processing is executed by the computer program. Thus, the same advantage as in the above embodiment can be easily obtained simply by installing the computer program in an ordinary computer via a computer-readable storage medium.

In addition, the software decoder according to the embodiment of the present invention is applicable not only to multimedia players, but also to PDAs and cellular phones, etc.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video decoding apparatus which decodes a compression-coded video stream, comprising:
a decoding module configured to decode syntax values of respective macroblocks included in a picture to be decoded in the video stream;
an error detection module configured to detect an error in the syntax values decoded by the decoding module;
an error concealment processing module configured to execute, in the case where the picture to be decoded whose error has been detected by the error detection module is an inter-frame prediction picture for which motion compensation prediction processing is performed, error concealment processing of rewriting the syntax values of the macroblock in which an error has been detected and its subsequent macroblocks so as to estimate, from information of the inter-frame prediction picture or data of macroblocks that have been decoded, data of the macroblock in which an error has been detected and its subsequent macroblocks;
a compensation prediction module configured to execute motion compensation prediction processing of generating, from one or more reference pictures, an inter-frame prediction signal corresponding to the picture to be decoded in accordance with the syntax values decoded by the decoding module or syntax values rewritten by the error concealment processing module;
an intra-frame prediction processing module configured to execute intra-frame prediction processing of generating an intra-frame prediction signal from the picture to be decoded in accordance with the syntax values decoded by the decoding module or syntax values rewritten by the error concealment processing module; and
a signal adding module configured to add one of the inter-frame prediction signal and intra-frame prediction signal to a prediction error signal corresponding to the picture to be decoded so as to decode the picture to be decoded.

2. The video decoding apparatus according to claim 1, wherein the error concealment processing module rewrites the syntax values of the macroblock in which an error has been detected and its subsequent macroblocks to set a mode in which the inter-frame prediction signal is generated from macroblocks corresponding to the reference pictures.

3. The video decoding apparatus according to claim 1, wherein the error concealment processing module rewrites the syntax values of the macroblock in which an error has been detected and its subsequent macroblocks to set a mode in which the inter-frame prediction signal is generated as a result of motion compensation.

4. The video decoding apparatus according to claim 1, wherein the error concealment processing module rewrites the syntax values of the macroblock in which an error has been detected and its subsequent macroblocks to set a mode in which the inter-frame prediction signal is generated by generating a motion vector from motion vector information of decoded macroblocks around the macroblock corresponding to the reference pictures.

5. The video decoding apparatus according to claim 1, wherein the error concealment processing module rewrites the syntax values of the macroblock in which an error has been detected and its subsequent macroblocks to set a skipped macroblock mode.

6. The video decoding apparatus according to claim 1, wherein the error concealment processing module rewrites the syntax values of the macroblock in which an error has been detected and its subsequent macroblocks so that the prediction error signal becomes 0.

7. A video decoding method which decodes a compression-coded video stream, comprising:
decoding syntax values of respective macroblocks included in a picture to be decoded in the video stream;
detecting an error in the syntax values decoded by the decoding processing;
executing, in the case where the picture to be decoded whose error has been detected by the error detection is an inter-frame prediction picture for which motion compensation prediction processing is performed, error concealment processing of rewriting the syntax values of the macroblock in which an error has been detected and its subsequent macroblocks so as to estimate, from information of the inter-frame prediction picture or data of macroblocks that have been decoded, data of the macroblock in which an error has been detected and its subsequent macroblocks;
executing motion compensation prediction processing of generating, from one or more reference pictures, an inter-frame prediction signal corresponding to the picture to be decoded in accordance with the decoded syntax values or syntax values rewritten by the error concealment processing;
executing intra-frame prediction processing of generating an intra-frame prediction signal from the picture to be decoded in accordance with the decoded syntax values or syntax values rewritten by the error concealment processing; and
adding one of the inter-frame prediction signal and intra-frame prediction signal to a prediction error signal corresponding to the picture to be decoded so as to decode the picture to be decoded.

8. The video decoding method according to claim 7, wherein the error concealment processing is processing of rewriting the syntax values of the macroblock in which an error has been detected and its subsequent macroblocks to set a mode in which the inter-frame prediction signal is generated from macroblocks corresponding to the reference pictures.

9. The video decoding method according to claim 7, wherein the error concealment processing is processing of rewriting the syntax values of the macroblock in which an error has been detected and its subsequent macroblocks to set a mode in which the inter-frame prediction signal is generated as a result of motion compensation.

10. The video decoding method according to claim 7, wherein the error concealment processing is processing of rewriting the syntax values of the macroblock in which an error has been detected and its subsequent macroblocks to set a mode in which the inter-frame prediction signal is generated by generating a motion vector from motion vector information of decoded macroblocks around the macroblock corresponding to the reference pictures.

11. The video decoding method according to claim 7, wherein the error concealment processing is processing of rewriting the syntax values of the macroblock in which an error has been detected and its subsequent macroblocks to set a skipped macroblock mode.

12. The video decoding method according to claim 7, wherein the error concealment processing is processing of rewriting the syntax values of the macroblock in which an error has been detected and its subsequent macroblocks so that the prediction error signal becomes 0.

13. A program which is stored in a computer-readable medium and allows a computer to decode a compression-coded video stream, comprising:
causing the computer to decode syntax values of respective macroblocks included in a picture to be decoded in the video stream;
causing the computer to detect an error in the syntax values decoded by the decoding processing;
causing the computer to execute, in the case where the picture to be decoded whose error has been detected by the error detection is an inter-frame prediction picture for which motion compensation prediction processing is performed, error concealment processing of rewriting the syntax values of the macroblock in which an error has been detected and its subsequent macroblocks so as to estimate, from information of the inter-frame prediction picture or data of macroblocks that have been decoded, data of the macroblock in which an error has been detected and its subsequent macroblocks;
causing the computer to execute motion compensation prediction processing of generating, from one or more reference pictures, an inter-frame prediction signal corresponding to the picture to be decoded in accordance with the decoded syntax values or syntax values rewritten by the error concealment processing;
causing the computer to execute intra-frame prediction processing of generating an intra-frame prediction signal from the picture to be decoded in accordance with the decoded syntax values or syntax values rewritten by the error concealment processing; and
causing the computer to add one of the inter-frame prediction signal and intra-frame prediction signal to a prediction error signal corresponding to the picture to be decoded so as to decode the picture to be decoded.

14. The program according to claim 13, wherein the error concealment processing is processing of rewriting the syntax values of the macroblock in which an error has been detected and its subsequent macroblocks to set a mode in which the inter-frame prediction signal is generated from macroblocks corresponding to the reference pictures.

15. The program according to claim 13, wherein the error concealment processing is processing of rewriting the syntax values of the macroblock in which an error has been detected and its subsequent macroblocks to set a mode in which the inter-frame prediction signal is generated as a result of motion compensation.

16. The program according to claim 13, wherein the error concealment processing is processing of rewriting the syntax values of the macroblock in which an error has been detected and its subsequent macroblocks to set a mode in which the inter-frame prediction signal is generated by generating a motion vector from motion vector information of decoded macroblocks around the macroblock corresponding to the reference pictures.

17. The program according to claim 13, wherein the error concealment processing is processing of rewriting the syntax values of the macroblock in which an error has been detected and its subsequent macroblocks to set a skipped macroblock mode.

18. The program according to claim 13, wherein
the error concealment processing is processing of rewriting the syntax values of the macroblock in which an error has been detected and its subsequent macroblocks so that the prediction error signal becomes 0.
